(19) United States
(12) Patent Application Publication
(10) Pub. No.: US 2013/0175897 A1
(43) Pub. Date: Jul. 11, 2013

(54) DISK RESONATOR AND ELECTRONIC COMPONENT

(71) Applicant: NIHON DEMPA KOGYO CO., LTD., Tokyo (JP)

(72) Inventors: Takahiro OHTSUKA, Saitama (JP); Noritoshi KIMURA, Saitama (JP)

(73) Assignee: NIHON DEMPA KOGYO CO., LTD., Tokyo (JP)

(21) Appl. No.: 13/733,896

(22) Filed: Jan. 4, 2013

(30) Foreign Application Priority Data
Jan. 10, 2012 (JP) 2012-002467

(51) Int. Cl. H02N 99/00

(52) U.S. Cl. CPC H02N 99/00
USPC 310/300

(57) ABSTRACT

A contour mode disk resonator includes a substrate, a disk-shaped vibration plate, a pair of input electrodes, a pair of output electrodes, a supporting joist with one end, and an absorbing portion. The pair of input electrodes is disposed to face one another via the vibration plate in a planar view. The pair of output electrodes is disposed to face one another via the vibration plate in a direction intersecting with a direction where the pair of input electrodes faces one another in the planar view. The one end is integrally secured to a portion corresponding to a vibration node that occurs by a contour vibration in an outer periphery of the vibration plate. The supporting joist includes an absorbing portion configured to absorb strain energy generated by the contour vibration in the supporting joist.

### CROSS-REFERENCE TO RELATED APPLICATIONS

This application claims the priority benefit of Japan application serial no. 2012-002467, filed on Jan. 10, 2012. The entirety of the above-mentioned patent application is hereby incorporated by reference herein and made a part of this specification.

### TECHNICAL FIELD

This disclosure relates to a contour mode disk resonator where a disk-shaped vibration plate is configured to vibrate in a wine glass mode, and an electronic component that includes this disk resonator.

### DESCRIPTION OF THE RELATED ART

Micro Electro Mechanical System (MEMS) technique allows manufacturing a microminiature high-performance electronic component, and is under development. One example is a micro resonator.

The micro resonator includes a disk resonator that includes a circular vibration plate. The vibration plate is disposed above a silicon substrate so as to face the substrate via a clearance. The vibration plate is supported on the substrate via supporting joists that extend from vibration nodes, which are formed in an outer peripheral portion in the case where the vibration plate is vibrated, outward in a radial direction of the vibration plate (Lee, J. Yan and A. A. Seshia, “Quality factor enhancement of bulk acoustic mode resonators through anchor geometry design,” Proceedings of Eurosensors XXII, Dresden, Germany, Sep. 7-10, 2008, pp. 536-539. 70). In the peripheral area of the vibration plate, for example, four electrodes are disposed to be equally spaced in the circumferential direction. A pair of electrodes, which faces each other via the vibration plate, is configured as input electrodes that input high frequency voltage, while the other pair of electrodes is configured as output electrodes that detect vibration of the vibration plate. In the resonator thus configured, an electrostatic attractive force acts on the vibration plate by input of the high frequency voltage. This vibrates the vibration plate in a wine glass mode (compound (2,1) mode) that alternately and periodically repeats an action where the vibration plate is contracted in a direction connecting both of the input electrodes and expands in a direction connecting both of the output electrodes, and an inverse action.

Generally, as a method for holding the disk resonator, the vibration nodes formed by vibration are held so as not to inhibit the vibration. This disk resonator has a structure where rod-shaped supporting joists extend outward from the vibration nodes in a radial direction of the vibration plate so as to support the distal end of the supporting joists. In this type of the structure, the vibrating portion and the supporting joist are integrally configured, thus generating a moment at the four vibration nodes.

Accordingly, strain energy is generated in the supporting joist, thus causing vibration energy leak. This increases an equivalent series resistance and deteriorates Q-value.

Japanese Unexamined Patent Application Publication No. 04-213910 discloses a structure for suppressing vibration leakage of the vibration plate. However, the structure does not suppress the vibration leakage of the contour mode disk resonator according to this disclosure.

A need thus exists for a disk resonator and an electronic component which are not susceptible to the drawback mentioned above.

### SUMMARY

According to an aspect of this disclosure, there is provided a contour mode disk resonator. The contour mode disk resonator includes a substrate, a disk-shaped vibration plate, a pair of input electrodes, a pair of output electrodes, a supporting joist with one end, and an absorbing portion. The disk-shaped vibration plate is supported above the substrate so as to face the substrate via a clearance. A bias voltage is to be applied to the vibration plate. The pair of input electrodes is disposed to face one another via the vibration plate in a planar view, so as to vibrate the vibration plate in a wine glass mode. The pair of output electrodes is disposed to face one another via the vibration plate in a direction intersecting with a direction where the pair of input electrodes faces one another in the planar view, so as to obtain an output signal based on a vibration of the vibration plate. The one end is integrally secured to a portion corresponding to a vibration node that occurs by a contour vibration in an outer periphery of the vibration plate. The supporting joist includes an absorbing portion configured to absorb strain energy generated by the contour vibration in the supporting joist.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating a schematic configuration of a main part of a disk resonator with electrical connections according to a first embodiment of this disclosure;

FIG. 2 is a perspective view of the disk resonator;

FIG. 3 is a perspective view illustrating a wiring board disposed on a substrate;

FIG. 4 is a plan view that schematically illustrates a vibration of the disk resonator;

FIG. 5A is an explanatory diagram illustrating an operation of a supporting portion of a disk resonator according to a reference example;

FIG. 5B is an explanatory diagrams illustrating an operation of a supporting portion of the disk resonator according to the first embodiment of this disclosure;

FIG. 5C is an explanatory diagrams illustrating the operation of the supporting portion of the disk resonator according to the first embodiment of this disclosure;

FIG. 6A is a longitudinal cross-sectional side view illustrating a part of the manufacturing process for the disk resonator;

FIG. 6B is a longitudinal cross-sectional side view illustrating a part of the manufacturing process for the disk resonator;

FIG. 7 is a longitudinal cross-sectional side view illustrating a part of the manufacturing process for the disk resonator;

FIG. 8 is a longitudinal cross-sectional side view illustrating a part of the manufacturing process for the disk resonator;

FIG. 9 is a longitudinal cross-sectional side view illustrating a part of the manufacturing process for the disk resonator;

FIG. 10 is a longitudinal cross-sectional side view illustrating a part of the manufacturing process for the disk resonator;

FIG. 11 is a longitudinal cross-sectional side view illustrating a part of the manufacturing process for the disk resonator;

FIG. 12 is a plan view illustrating a vibration plate according to another embodiment of this disclosure;

FIG. 13 is a perspective view illustrating a supporting portion of the vibration plate according to the other embodiment of this disclosure; and

FIG. 14A to 14C are characteristic diagrams illustrating generated strain energy in the case where the disk resonator according to the embodiment of this disclosure is employed.

### DETAILED DESCRIPTION

### First Embodiment

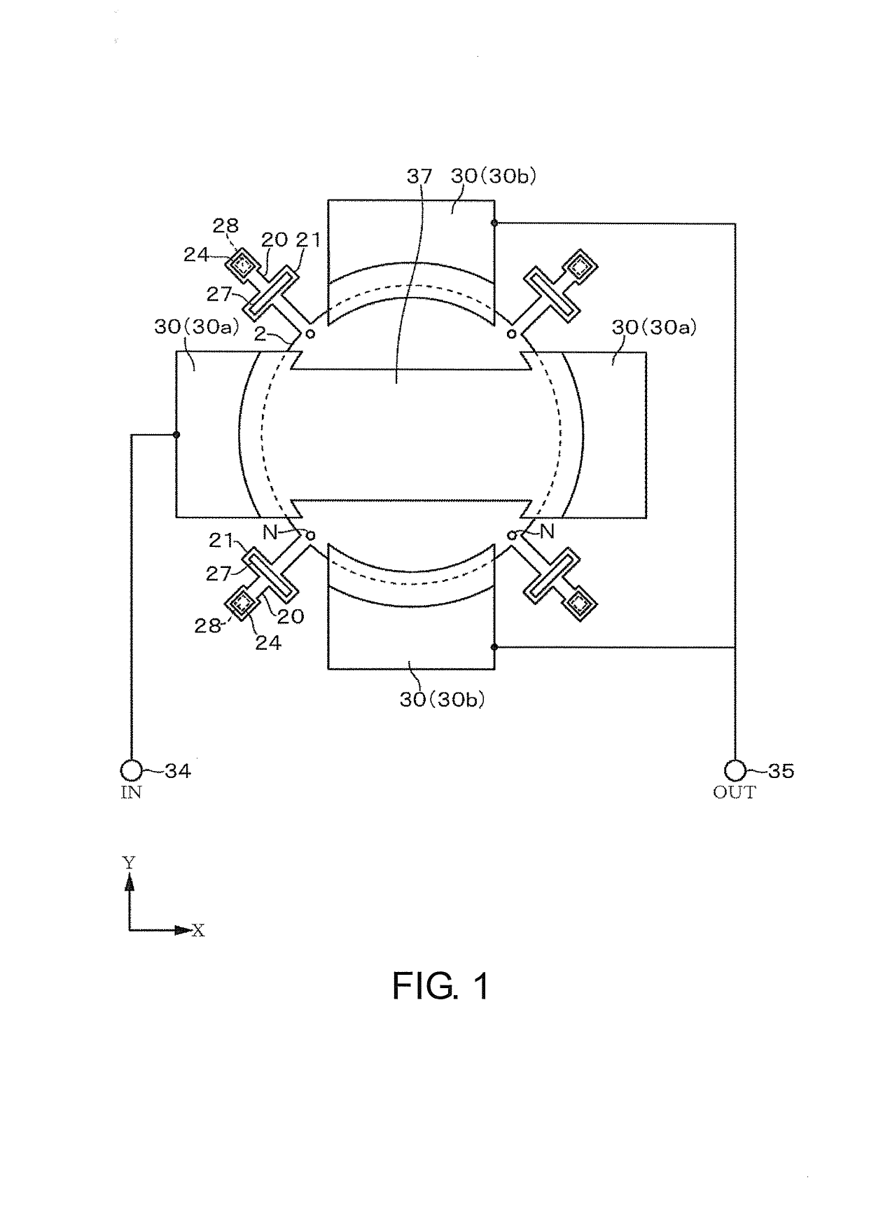

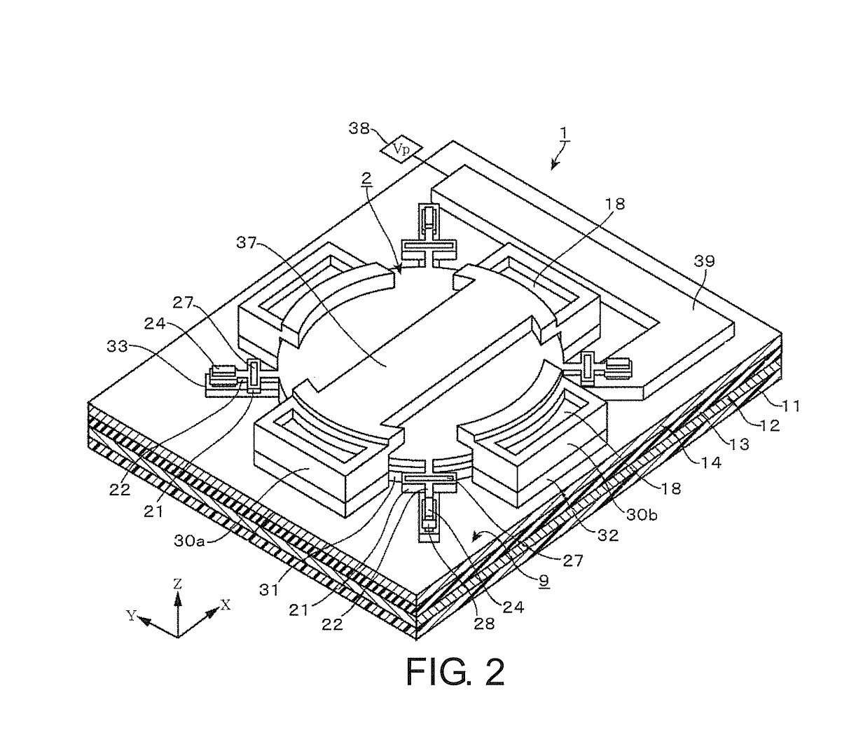

As illustrated in FIGS. 1 to 3, a disk resonator 1 according to an embodiment of this disclosure includes a vibration plate 2, which is a disk-shaped vibrating body. The vibration plate 2 is supported by supporting joists 20, which is described below, so as to face a substrate 9 via a clearance. The supporting joists 20 are disposed at four positions around the vibration plate 2. The vibration plate 2 is configured so as to resonate (vibrate) in a wine glass mode (compound (2,1) mode) by electrodes 30.

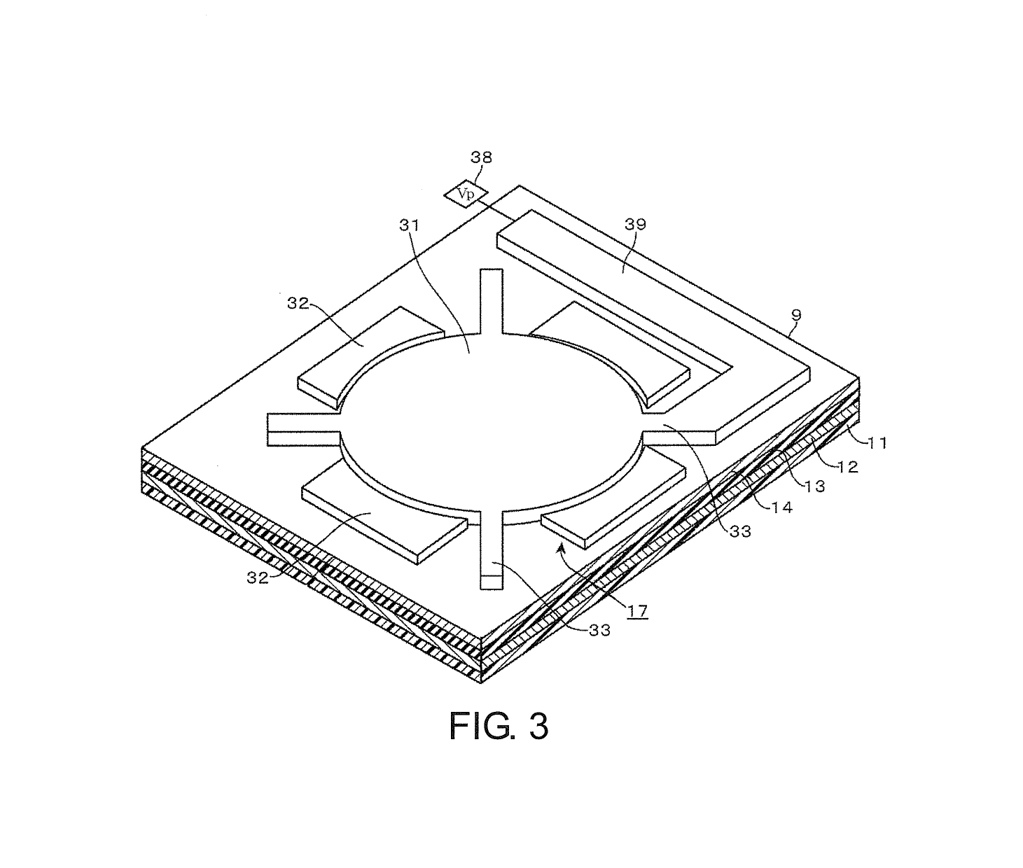

The substrate 9 is configured such that a silicon (Si) substrate 11, a silicon film doped with phosphorus (P) (phosphorus-doped silicon film 12), a silicon oxide film 13, a silicon nitride film 14 are laminated from the lowest layer in this order. The vibration plate 2 is, for example, disk-shaped with a diameter of 38 μm. For example, the vibration plate 2 is made of deposited polysilicon. Four electrodes 30 are disposed at the sides of the vibration plate 2 so as to have a void between the vibration plate 2 and respective electrodes 30. These four electrodes 30 are disposed on the substrate 9 so as to be equally spaced in the circumferential direction of the vibration plate 2. Namely, the pairs of electrodes 30, which are disposed at four positions around the vibration plate 2 and face each other via the vibration plate 2, are each configured as input electrodes 30a or output electrodes 30b. FIG. 3 illustrates a surface structure (structure of a conductive film 17) of the substrate 9 at the lower side of the vibration plate 2 and the electrodes 30. A circular shape portion 31 is formed in the lower projection area of the vibration plate 2 on the surface of the substrate 9. On the surface of the substrate 9, an electrode-disposed portion 32 is further formed at the position under each electrode 30, and extended portions 33, which each extend outside from the outer periphery of the circular shape portion 31, are formed between four electrode-disposed portions 32. A conductive path 39 for extraction is further connected to one of these extended portions 33. The circular shape portion 31, the electrode-disposed portions 32, the extended portions 33, and the conductive path 39 for extraction are constituted with a conductive material, which includes a silicon film and similar member. The conductive path 39 for extraction is extended on the substrate 9 to connect a bias voltage applying unit 38, which is disposed outside of the substrate 9, via a conductive body such as a wire.

An approximately box-shaped electrode 30, which is made of polycrystalline silicon, is formed on each of the aforementioned four electrode-disposed portions 32. The electrode 30 has a top surface that is positioned at slightly higher level than the vibration plate 2. The electrode 30 has a surface at the vibration plate 2 side, which curves along the peripheral edge of the vibration plate 2. The electrode 30 has an upper portion that extends over the top surface of the vibration plate 2 and the peripheral edge portion. Thus, the electrode 30 has an L shape from a lateral view. On the top surface of the electrode 30, a depressed portion 18 is formed. The depressed portion 18 is generated when a structure, which includes the electrode 30, on the substrate 9 is formed in a photolithography process.

A pair of input electrodes 30a is connected to each other via a conductive body 37, which bridges over the vibration plate 2 with a clearance. The input electrodes 30a have the same electric potential. For example, one of these input electrodes 30a is connected to an input port 34, which is disposed on the substrate 9 and receives high frequency voltage as an input signal, via the conductive path such as a wire. A pair of output electrodes 30b are connected to each other, for example, via a conductive body such as a wire at a further upper position above the conductive body 37, and are connected to an output port 35, which is disposed on the substrate 9 and outputs a frequency signal detected at the pair of output electrodes 30b. Among the frequency signals input to the input port 34, the output port 35 outputs the frequency signal that corresponds to a resonance frequency of the disk resonator. Due to an electrostatic bond caused by the input electrodes 30a, the vibration plate 2 repeats a stretching vibration in the radial direction, along the direction where the input electrodes 30a face each other, thus vibrating in the wine glass mode. At this time, vibration nodes N are generated at each position at an angle of 45° with respect to a straight line that connects both centers of the input electrodes 30a and passes through the center of the vibration plate 2.

A supporting joist 20 extends outward from each of four portions corresponding to vibration nodes N on the vibration plate 2, along an extended line of the diameter of the vibration plate 2. The above-described extended portion 33 that extends from the circular shape portion 31, which is below the vibration plate 2, on the substrate 9 is positioned on an projection area of each supporting joist 20. One end side of the supporting joist 20 and the vibration plate 2 are integrally configured (integrally secured). The other end side (the distal end side) of the supporting joist 20 is formed as a rectangular-shaped portion, which is slightly expanded laterally with respect to the longitudinal direction of the supporting joist 20. A rectangular-shaped through hole 28 is formed in the center of the rectangular-shaped portion. This through hole 28 is configured as a securing portion to secure the supporting joist 20. A support pillar 24 is vertically disposed on the extended portion 33 on the substrate 9. The support pillar 24 passes through the through hole 28 in a state where the support pillar 24 tightly fits the through hole 28. The support pillar 24 is expanded at an upper position than the through hole 28. Thus, the supporting joist 20 is electrically connected to the above-described conductive path 39 for extraction via the support pillar 24, and secured to the substrate 9. Accordingly, the vibration plate 2 is supported by the substrate 9 at four positions via the supporting joists 20 and the support pillars 24, and is positioned to face the conductive film 17, which is disposed on the surface of the substrate 9, via a clearance.

The supporting joist 20 has an absorbing portion 21 for absorbing a strain energy generated in the supporting joist 20 when a contour vibration occurs. The absorbing portion 21 is configured as follows. The portions on the right and left sides of the supporting joist 20 are locally expanded to have laterally expanded portions in a straight line shape in a direction perpendicular to the supporting joist 20 so as to form a rectangular-shaped expanded portion, which is laterally long. A laterally long through hole (hereinafter referred to as slit 27) is formed in this expanded portion. The slit 27 has a length that is longer than a lateral width of portions of the support pillar 24 except the expanded portion. In other words, the absorbing portion 21 has a shape of a double-ended tuning fork. This double-ended tuning fork has a shape that includes two members in a shape of a tuning fork disposed to face each other where end surfaces at the free end side of the two members face each other and are joined.

Next, a description will be given of an operation of the above-described embodiment. A bias voltage is applied to the vibration plate 2 from the bias voltage applying unit 38 via the conductive path 39 and the supporting joist 20. In this state, inputting a high frequency signal as an input signal from the input port 34 generates an electrostatic attractive force between the vibration plate 2 and the input electrode 30a. This causes the vibration plate 2 to repeat stretching and contracting back and forth and right and left, and vibrates in the wine glass mode. The output electrode 30b detects a change of capacitance, which is caused by a resonance of the vibration plate 2, and outputs a detected output signal from the output port 35.

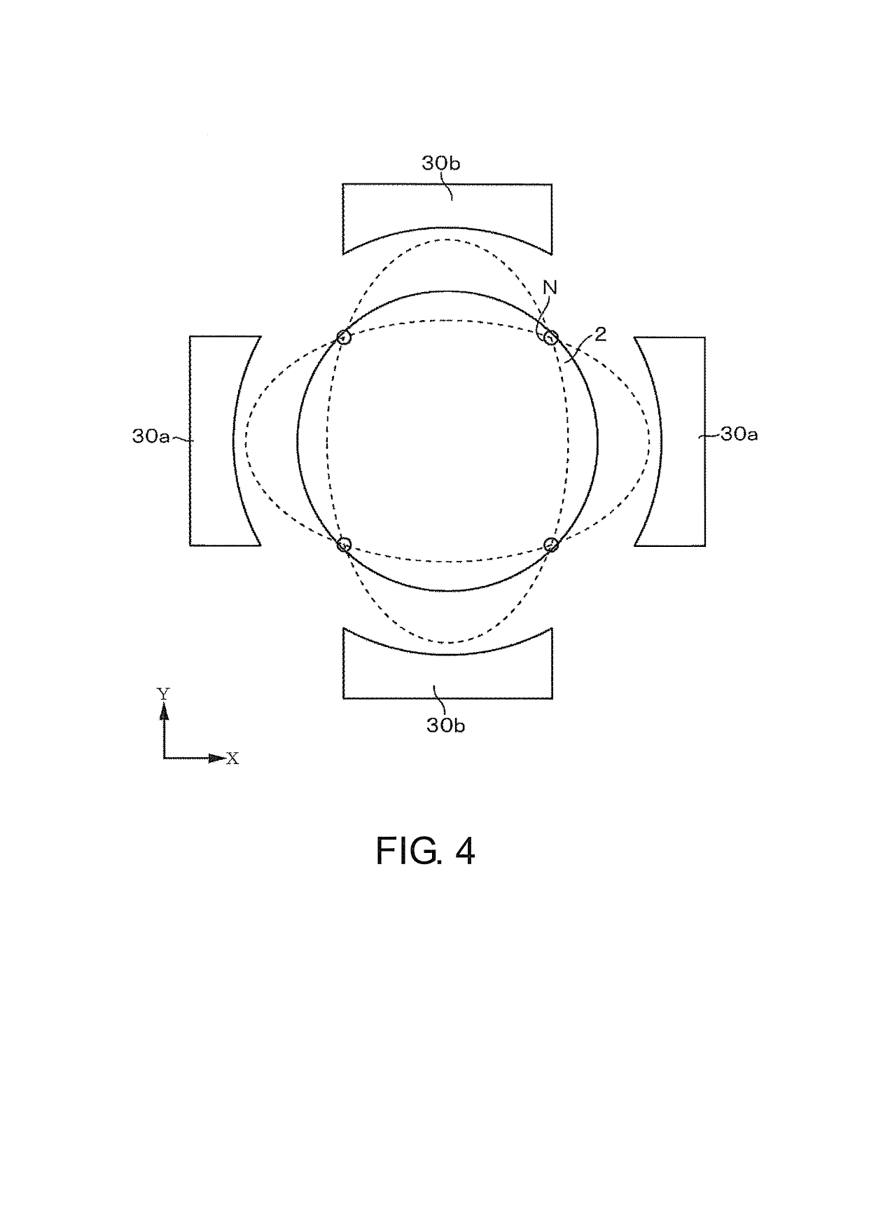

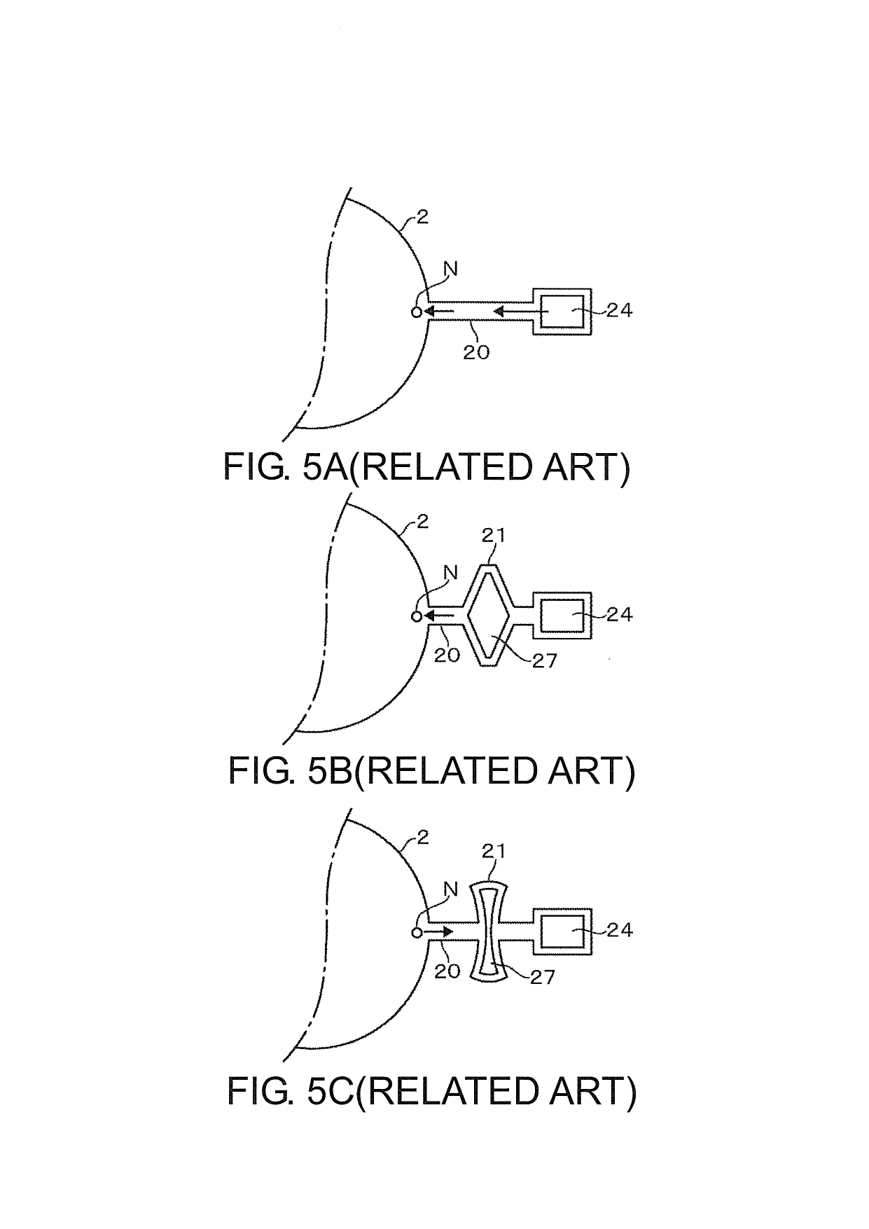

As illustrated in FIG. 4, when the vibration plate 2 has a stretching vibration, an action of stretching in the X direction and contracting in the Y direction, and an action of contracting in the X direction and stretching in the Y direction are alternately repeated with a predetermined period. Thus, four points in the outer peripheral portion of the vibration plate 2, which are in a direction of 45° with respect to the X axis or the Y axis when viewed from the center of the vibration plate 2, and the center of the vibration plate 2 become the vibration nodes N and do not vibrate. As described above, the supporting joist 20 extends from the vibration node N, which is formed in the outer peripheral portion of the vibration plate 2. The supporting joist 20 and the vibration plate 2 are integrally configured. The support pillar 24 tightly fits the through hole 28, which is disposed at the distal end of the supporting joist 20, so as to be secured to the substrate 9. In the case where a disk resonator 1 as a reference example, which has the supporting joist 20 without the absorbing portion 21, is vibrated in the wine glass mode, strain energy is generated in the supporting joist 20 when a moment is generated at the vibration node N as illustrated in FIG. 5A. In the case where the strain energy is generated in the supporting joist 20, vibration energy of the vibration plate 2 leaks out, this results in a deterioration of Q-value of the disk resonator 1.

However, when the disk resonator 1 according to this disclosure generates a vibration, a moment is applied to the vibration node N, and strain energy is transmitted from the vibration plate 2 to the supporting joist 20, thus deforming the absorbing portion 21. This absorbs the strain energy generated in the supporting joist 20. For example, as illustrated in FIG. 5B, in the case where the moment is generated at the vibration node N, and a pulling force in a direction where the supporting joist 20 is pulled toward the vibration plate 2 is transmitted to the supporting joist 20, the slit 27 of the absorbing portion 21 is expanded to the pulled direction of the supporting joist 20, thus suppressing the pulling load generated on the support pillar 24. As illustrated in FIG. 5C, in another case where a pushing force is generated in a direction where the supporting joist 20 is pushed toward the support pillar 24, the slit 27 is deformed to be narrowed, thus absorbing the strain energy generated in the supporting joist 20. Accordingly, the leakage of the vibration energy from the supporting joist 20 is suppressed even if the moment is generated at the vibration node N.

The disk resonator according to the above-described embodiment is the contour mode disk resonator where the vibration plate 2 is vibrated in the wine glass mode. The supporting joist 20 extends outward from the vibration node N, which occurs in the outer peripheral portion of the vibration plate 2, and is integrally configured with the vibration plate 2. The supporting joist 20 has the absorbing portion 21 in the shape of the double-ended tuning fork. In the case where the contour vibration in the wine glass mode occurs in the vibration plate 2, the stretching and contracting operation of the absorbing portion 21 absorbs the strain energy generated in the supporting joist 20. Even if the moment is generated at the vibration node N, the leakage of the vibration energy from the supporting joist 20 is suppressed. This suppresses the deterioration of the Q-value. For example, in the case where the disk resonator according to this disclosure is employed as a filter, it has a low-loss and good attenuation characteristic, and is appropriate for an electronic component such as a band-pass filter.

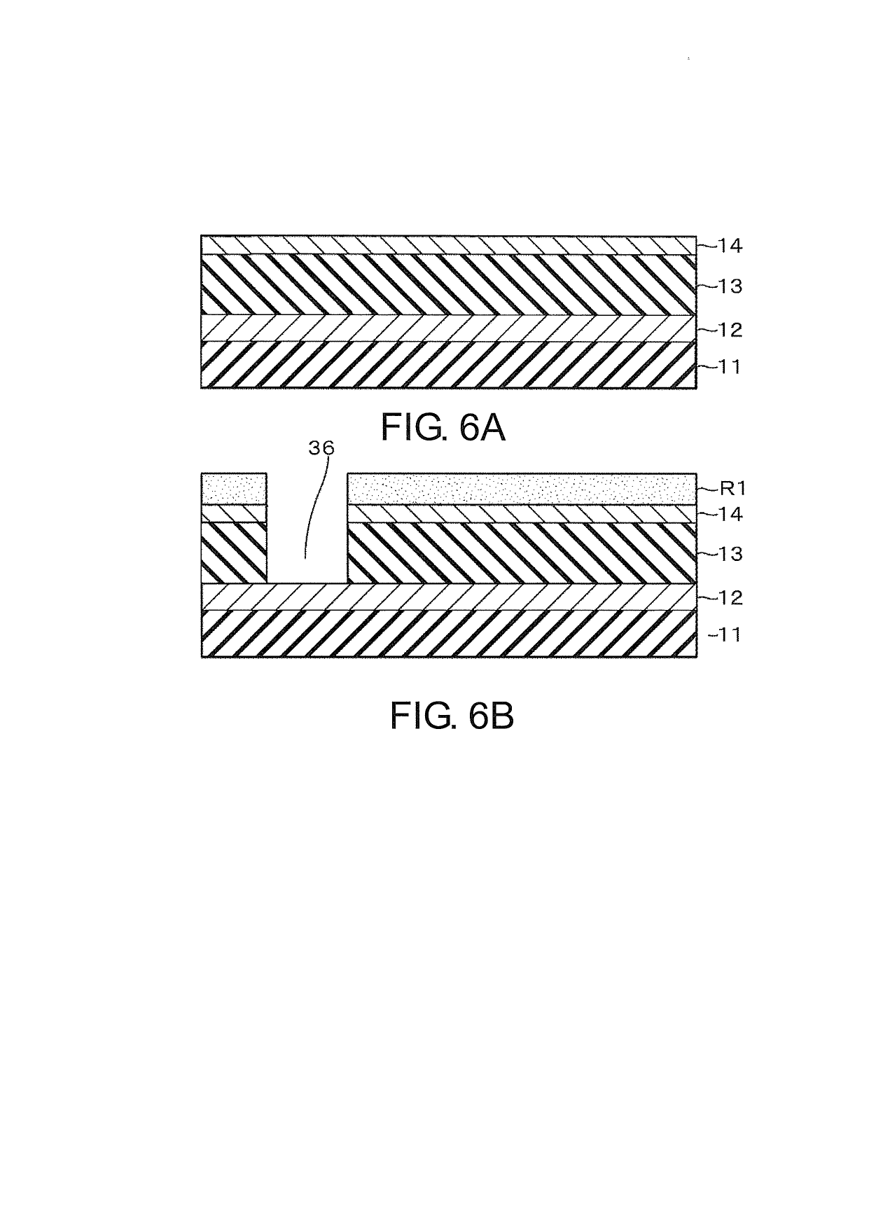

An exemplary method for manufacturing the above-described disk resonator using the MEMS method will be described by referring to the following FIG. 6A to FIG. 11. First, as illustrated in FIG. 6A, a phosphorus ion is implanted into the silicon substrate 11, and the silicon substrate 11 is heated to spread phosphorus on the surface of the silicon substrate 11, so as to form the phosphorus-doped silicon film 12. Next, the silicon oxide film 13 and the silicon nitride film 14 are laminated on the silicon substrate 11 from the lower side in this order. Subsequently, as illustrated in FIG. 6B, the phosphorus-doped silicon film 12 is exposed by photolithography and dry etching. In FIG. 6B, R1 denotes a resist.

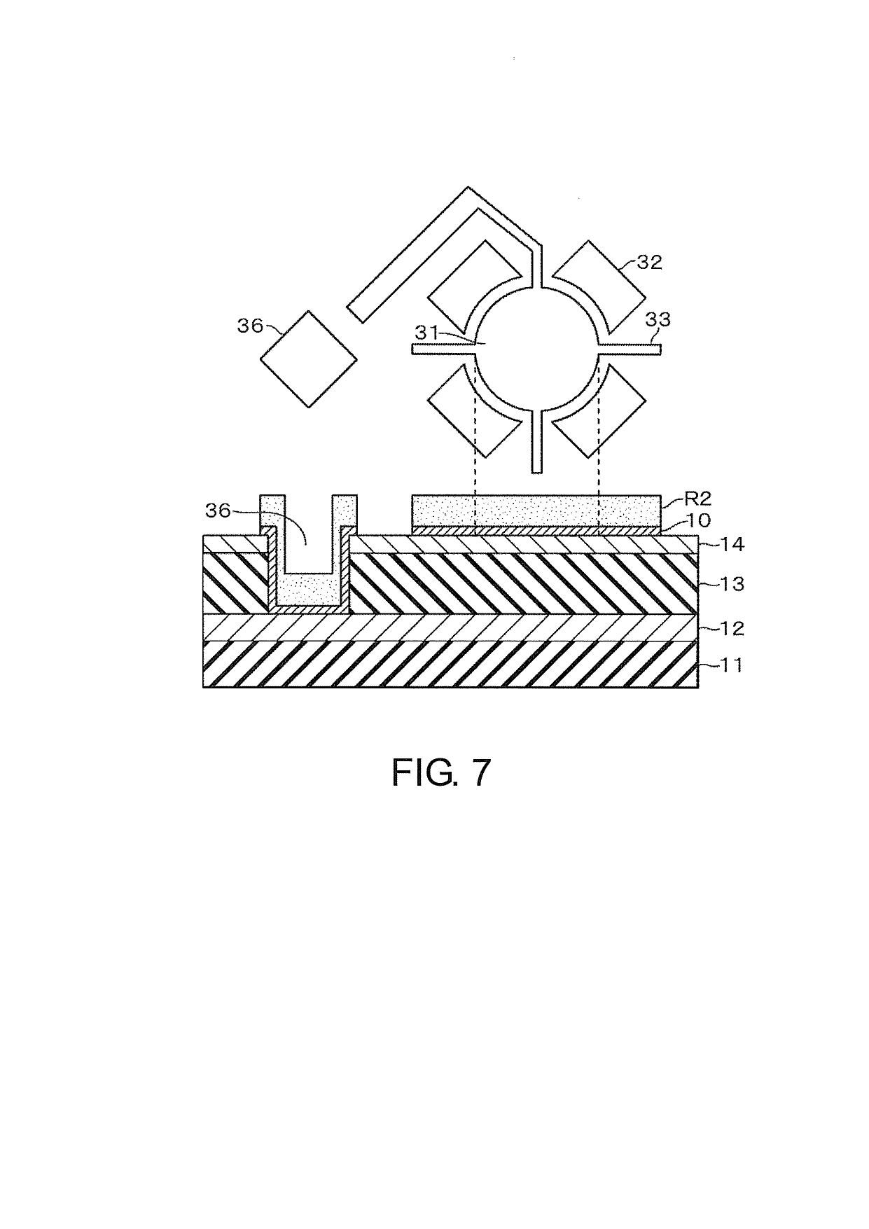

Next, as illustrated in FIG. 7, a first polysilicon film 10 is formed on the silicon nitride film 14. Phosphorus is then spread on the first polysilicon film 10. Subsequently, portions other than portions, which correspond to the vibration plate 2, the respective electrodes 30, and the conductive path 39 for extraction, of the first polysilicon film 10, are dry-etched by photolithography. In FIG. 7, R2 denotes a resist.

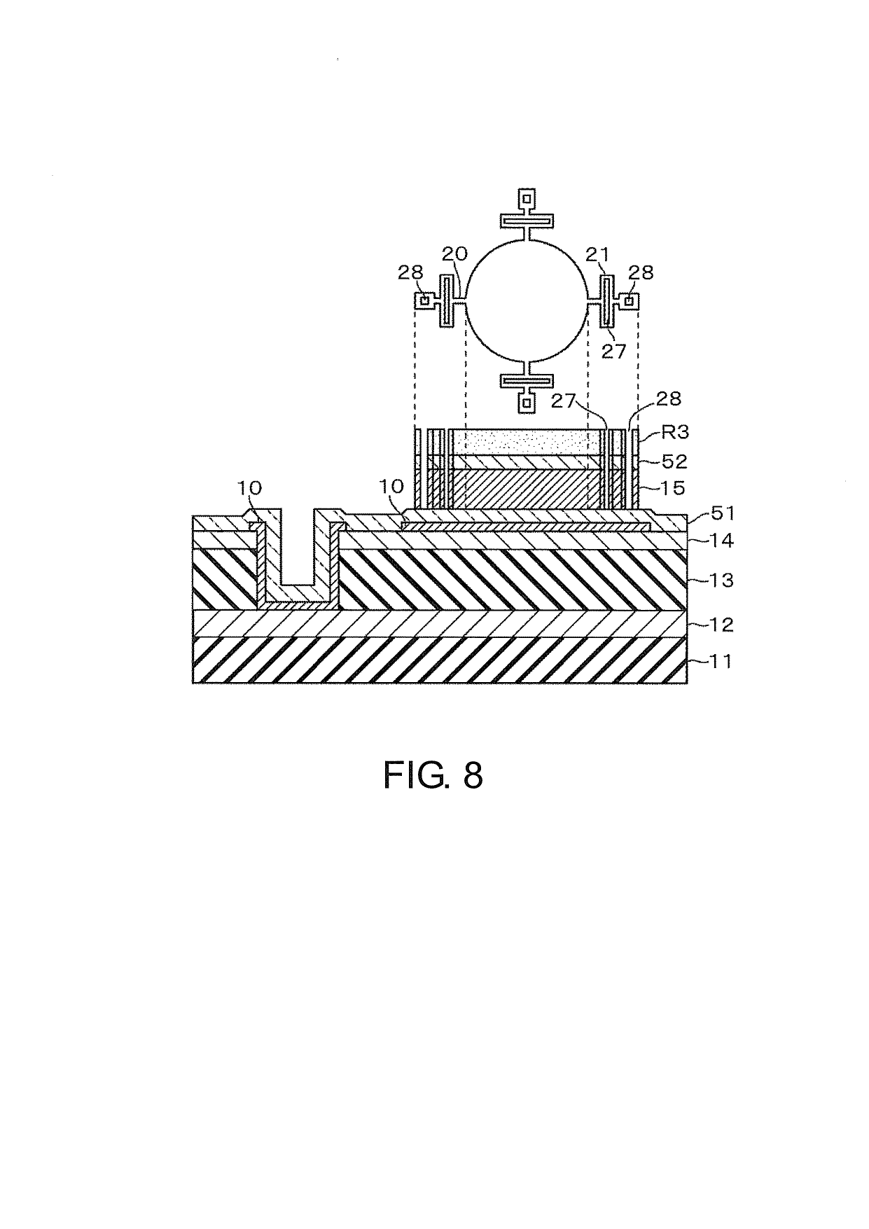

Subsequently, after the resist R2 is removed, a first sacrifice film 51, a phosphorus-doped polysilicon film 15, and a second sacrifice film 52 are laminated on the surface of the laminated body made through the above-described processes from the lower side in this order. The first sacrifice film 51 is made of, for example, silicon oxide. The second sacrifice film 52 is made of, for example, a silicon oxide film, and has the same film thickness as that of the first sacrifice film 51. Then, a third resist film R3 is formed on the upper layer side of the second sacrifice film 52. The third resist film R3 is patterned to correspond to the shape of the vibration plate 2 with the extended supporting joist 20. FIG. 8 illustrates a state after this etching.

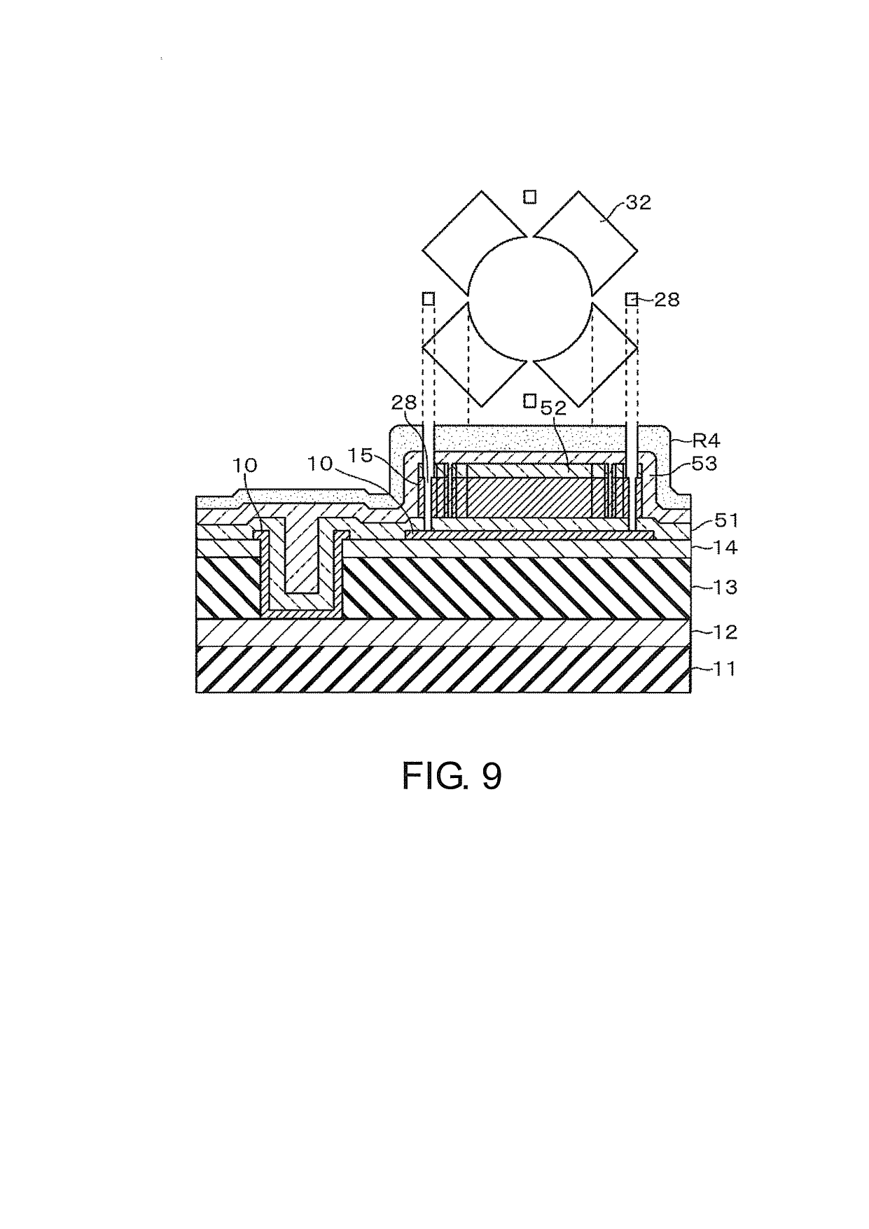

Next, as illustrated in FIG. 9, after the resist film R3 is removed, a structure with the through holes 28 and spaces is formed. The through holes 28 and spaces are formed by etching. The through holes 28 are to be connected to the support pillars 24, and the electrodes 30 are to be disposed in the spaces. R4 denotes a resist film. A third sacrifice film 53, which is made of silicon oxide, is formed as a gap oxide film over the upper layer side of the second sacrifice film 52. The third sacrifice film 53 is formed to be inside of the through hole 28 of the supporting joist 20 and the slit 27 of the absorbing portion 21. Above the third sacrifice film 53, the upper portion of the through hole 28 of the supporting joist 20 is dry-etched to open slightly wider than the through hole 28 and to open in an area corresponding to each electrode 30. This exposes the first polysilicon film 10 at the bottom surfaces of the through holes 28 and in the areas where the electrode 30 are to be formed. This also exposes an area around the through holes 28 above the second polysilicon film 15.

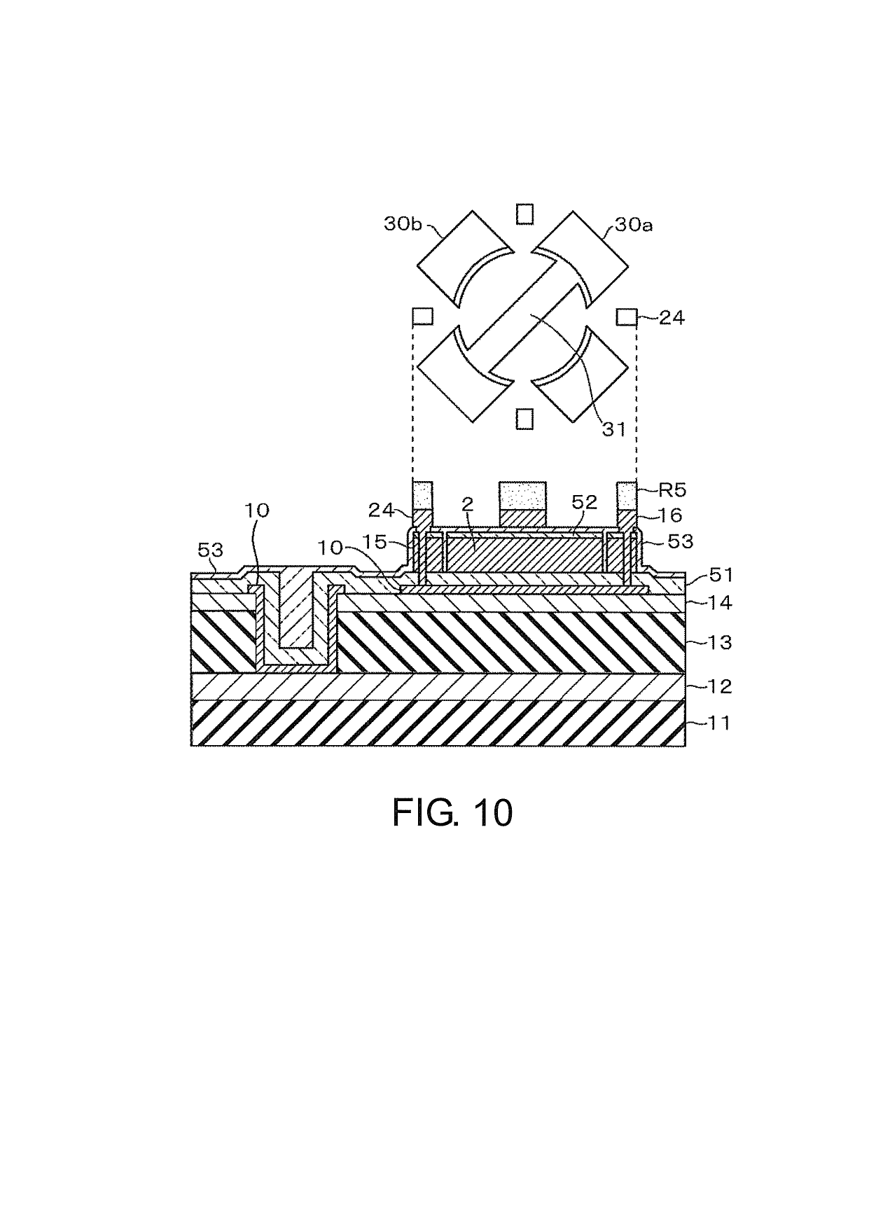

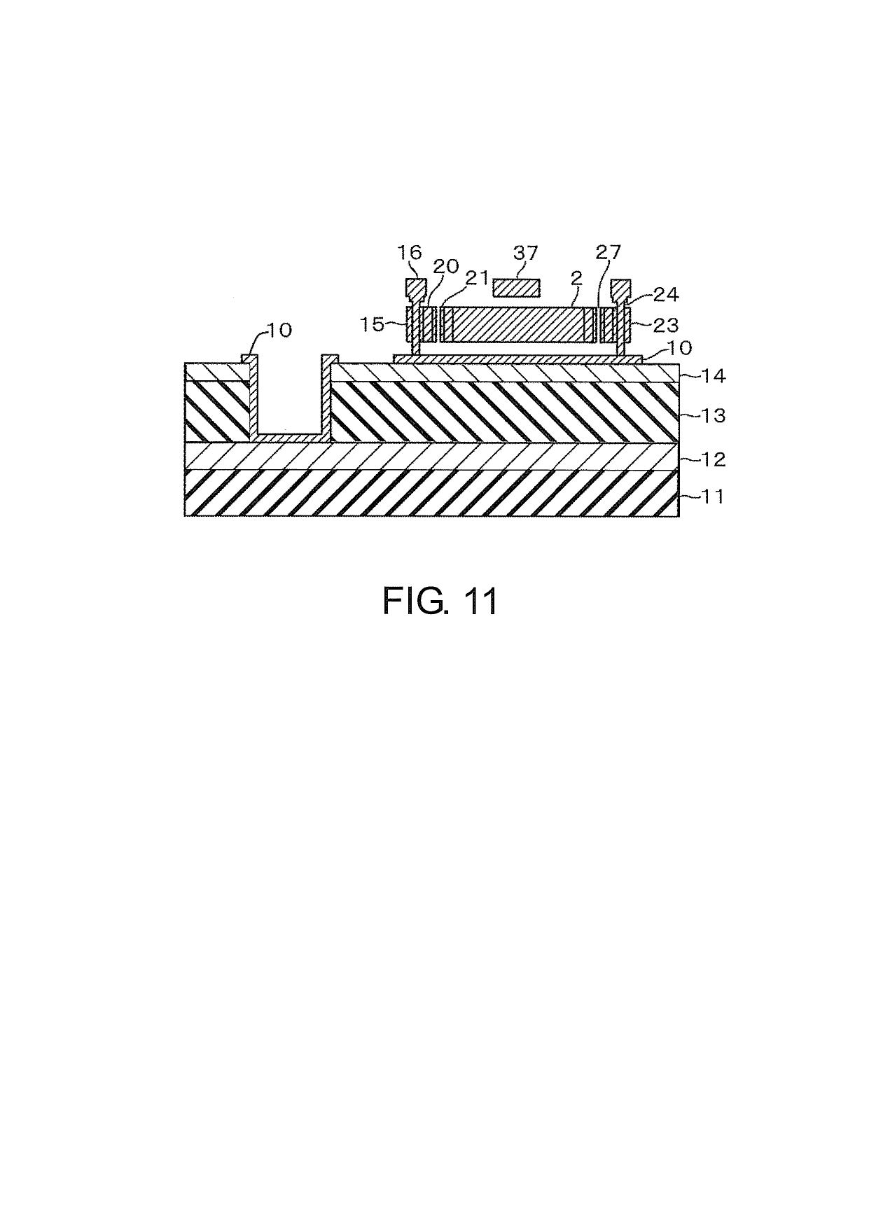

Then, the fourth resist film R4 is removed. A third phosphorus-doped polysilicon film 16 illustrated in FIG. 10 is filled in inside regions of the through holes 28. A structure where areas other than each electrode 30, the support pillar 24, and the conductive path 39 are opened is formed by etching. Subsequently, the resist R5 is removed. Then, the sacrifice films 51 and 52 are removed by an etchant such as hydrogen fluoride solution. Thus, as illustrated in FIG. 11, a structure where the supporting joist 20 and the vibration plate 2 float above the first polysilicon film 10, and the vibration plate 2 is supported by the support pillar 24 is formed.

The supporting joists 20, which support the vibration plate 2, in the disk resonator according to this disclosure are not necessarily disposed at the four positions, and may be disposed at one to three positions. Instead of the structure with the total four layers including the phosphorus-doped silicon film 12, the silicon oxide film 13, and the silicon nitride film 14 on the silicon substrate 11, a three-layer structure where the silicon oxide film and the silicon nitride film are formed on the silicon substrate 11 from the lower side in this order may be employed. In the example described above, the conductive path such as a wire is employed to input the signal to the input electrode 30a. However, a conductive film that extends horizontally from the first polysilicon film 10 below the input electrode 30a may be formed to input the signal via this conductive film. The vibration plate 2 in a precise circle shape is described. However, the vibration plate 2 may be in an ellipse shape, a quadrangular shape, or other shapes. The shape of the absorbing portion 21 is not necessarily in the shape of the double-ended tuning fork, and may be in a disk shape which has a circular-shaped hole in the center.

### Second Embodiment

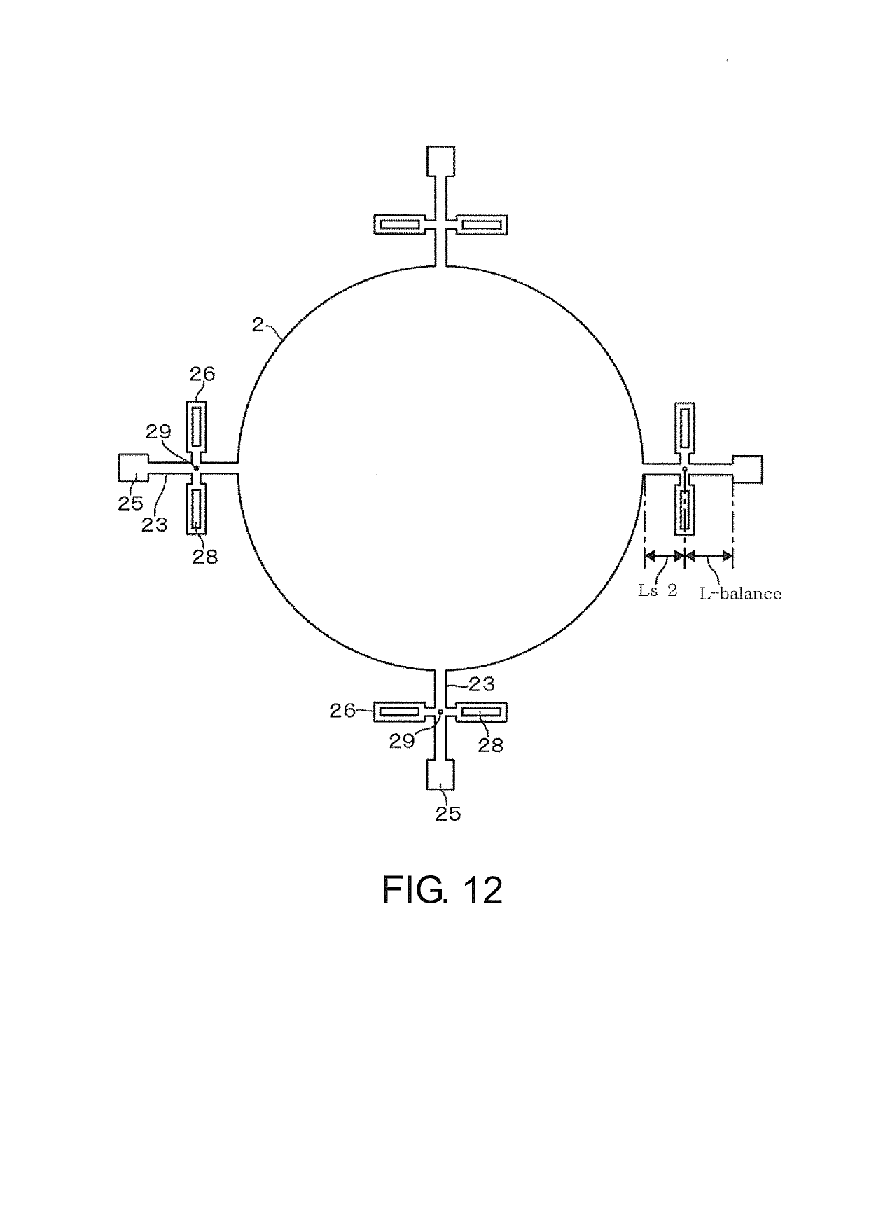

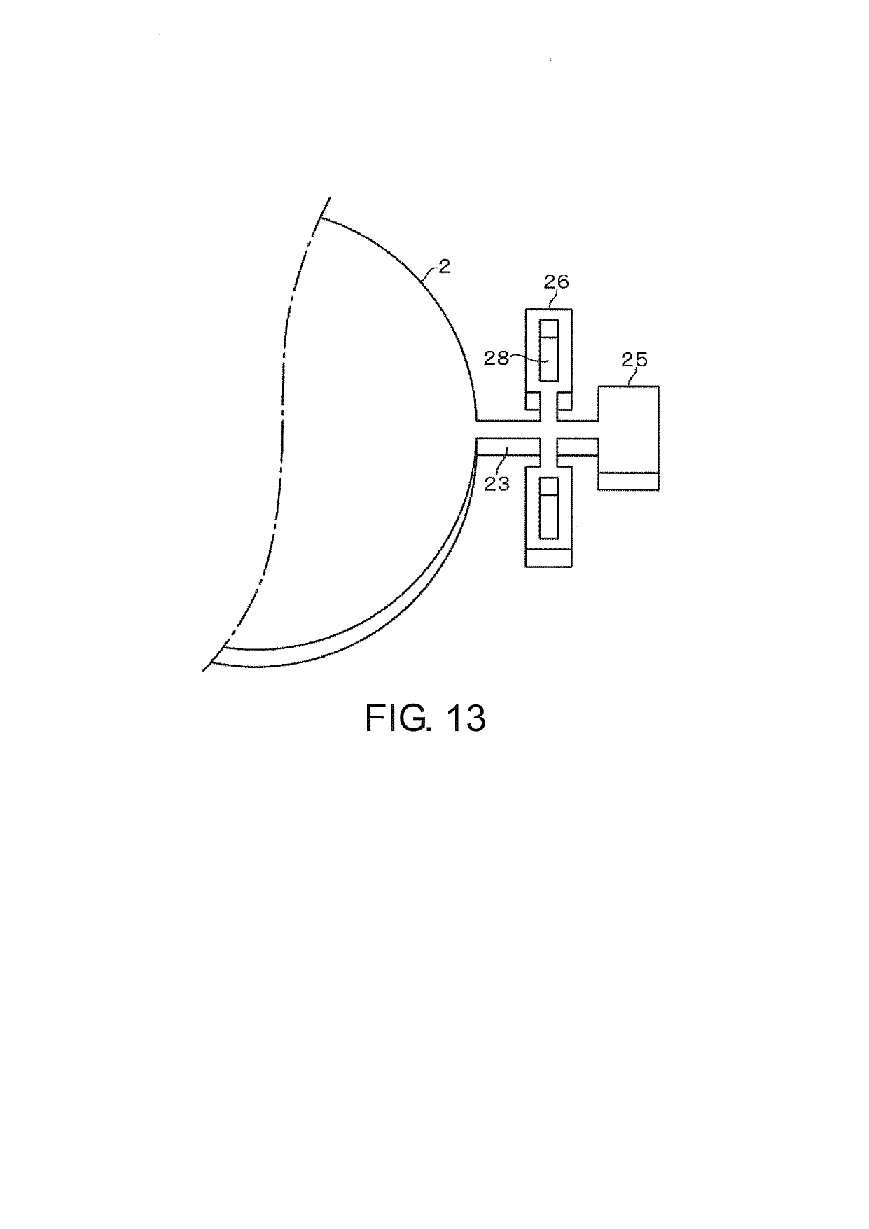

As illustrated in FIGS. 12 and 13, the second embodiment includes the four supporting joists 20, which extend outward from the vibration plate 2, similarly to the first embodiment. However, the following configuration is different. Namely, the supporting joist 20 includes a main joist 23, which extends outward from the vibration plate 2 in the radial direction of the vibration plate 2, and a pair of subsidiary joists 26. The pair of subsidiary joists 26 symmetrically extends from the right and left sides of the middle portion of the main joist 23 with respect to the extending direction of the main joist 23. In this example, these subsidiary joists 26 extend in a direction perpendicular to the extending direction of the main joist 23. Each of the subsidiary joists 26 is expanded in a direction perpendicular to the extending direction of the subsidiary joist 26 so as to form an expanded portion. This expanded portion has a slit-shaped through hole 28, which extends longer than a width of a portion adjacent to the expanded portion in the subsidiary joist 26. Each of the through holes 28 tightly fits the support pillar 24, which vertically extends from the extended portion 33 on the substrate 9. The support pillar 24 is connected to the conductive path 39 and the bias voltage applying unit 38 so as to apply a bias voltage to the vibration plate 2. On the other end side (the distal end side) with respect to a middle portion 29 (the portion from which the subsidiary joist 26 extends) of the main joist 23, a weight portion 25, which has a rectangular-shaped expanded portion where the main joist 23 is expanded on the right and left side, is disposed.

The disk resonator 1 according to the second embodiment has the weight portion 25 at the distal end of the main joist 23. Thus, when the vibration plate 2 is vibrated, the weight portion vibrates, and a vibration node N is formed at the middle portion 29. Accordingly, a moment generated at the middle portion 29 is reduced. This suppresses the leakage of the vibration energy, from the supporting joist 20, thus suppressing the deterioration of the Q-value of the disk resonator 1.

### WORKING EXAMPLES

Characteristics of the disk resonator according to the embodiments of this disclosure were examined.

### Simulation

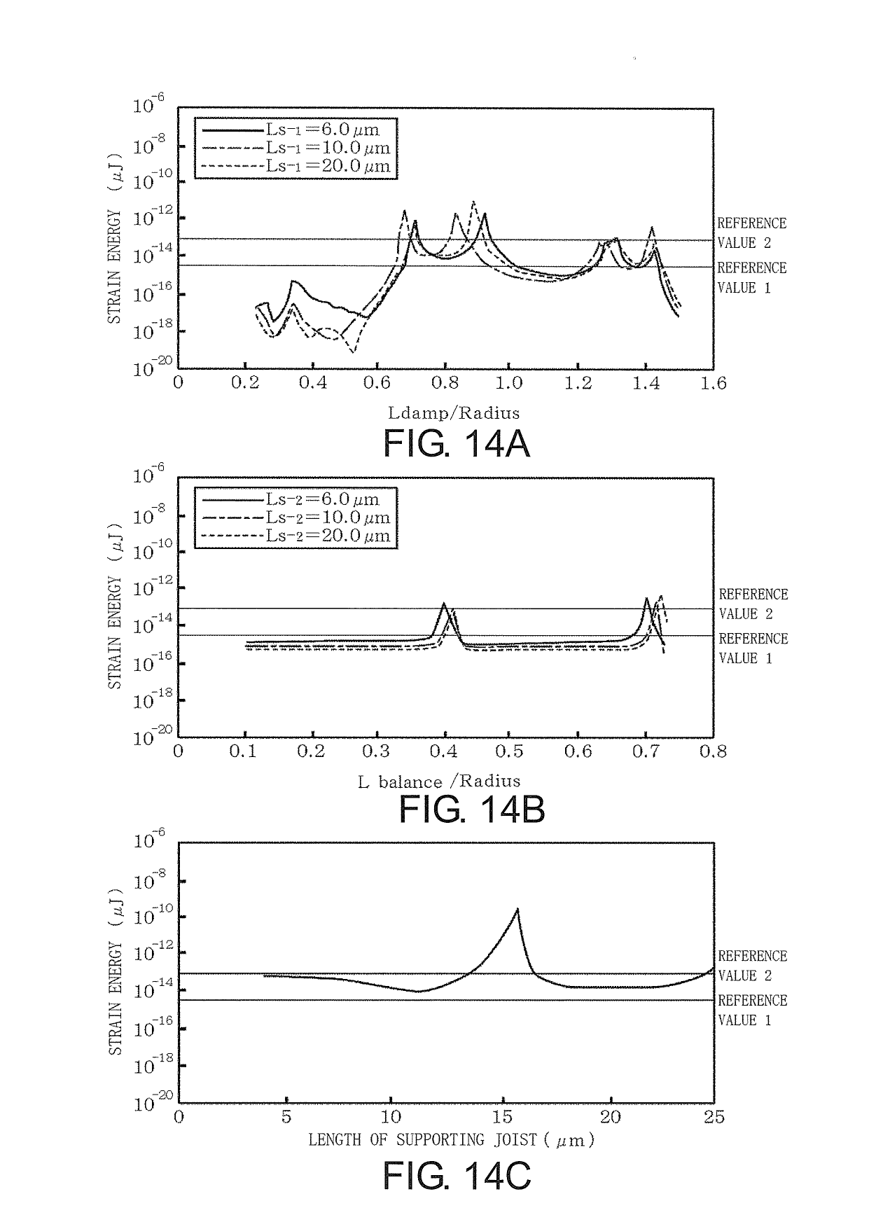

According to each of the first embodiment and the second embodiment, strain energy U, which is generated in the supporting joist 20, was calculated by the following equation (1) based on stress and strain, which is generated in the vibration plate 2 and obtained with the FEM analysis method (the finite element method). In the equation (1), D denotes the volume of the distal end of the supporting joist 21, τᵢⱼ denotes the stress tensor, and eᵢⱼ denotes the strain tensor. Reference values shown in FIGS. 14A to 14C were obtained as follows. A flat cylinder, which has a diameter of 2.0 μm and a length of 700 nm, extends from the center of the vibration plate 2, and supports a circular substrate, which has a diameter of 80 μm and a thickness of 900 nm. Strain energy that is generated in this circular substrate when the vibration plate 2 is vibrated is obtained as the reference value 1. The center of the vibration plate 2 corresponds to the vibration node that has a smaller displacement of the vibration than the vibration node N, which occur in the outer periphery of the vibration plate 2. Assuming that the diameter of the cylinder is 4.0 μm, the strain energy is similarly obtained as the reference value 2. A structure according to each embodiment was evaluated using graphs that show the reference values 1 and 2, and strain energy in each embodiment.

U=½∫_{D}τᵢⱼeᵢⱼdV (1)

### Working Example 1

In the disk resonator 1 according to the first embodiment, various values were set to Lₛ₋₁ (a length of the supporting joist 20 between the vibration plate 2 and the absorbing portion 21), and strain energy was obtained for each value. FIG. 14A is a characteristic diagram illustrating the result where L_{damp} (a length of the slit 27 disposed in the absorbing portion 21)/Radius (a radius of the vibration plate 2) is on the horizontal axis, and the strain energy is on the vertical axis. Lₛ₋₁ was set to a length of 6.0 μm, 10.0 μm, and 20.0 μm.

In the case where L_{damp}/Radius is equal to or less than 0.6, the strain energy is suppressed to be equal to or less than 1/100, compared with the reference value 1. In the simulation, when Lₛ₋₁ is equal to 20 μm and L_{damp}/Radius is equal to 0.526, the strain energy is minimized, and the energy of the vibration leakage is minimized.

### Working Example 2

In the disk resonator according to the second embodiment, the weight of the weight portion disposed at the distal end of the main joist 23 was set to 46.6×10⁻¹² g, various values were set to Lₛ₋₂ (a length of the supporting joist 20 from the vibration plate 2 to a supporting point 26), and strain energy was obtained for each value. FIG. 14B a characteristic diagram illustrating the result where L_{Balance} (a length of the main joist 23 from the middle portion 29 to the center of gravity of the weight portion 25)/Radius is on the horizontal axis and the strain energy is on the vertical axis. Lₛ₋₂ was set to a length of 6.0 μm, 10.0 μm, and 20.0 μm. In the case where L_{Balance}/Radius is equal to 0.4, the strain energy is large. When Lₛ₋₂ is equal to 6.0 μm, 10.0 μm, and 20.0 μm, the strain energy has a smaller value than the reference value 1 in the case where L_{Balance}/Radius is equal to or less than 0.35. In the simulation, when Lₛ₋₂ is equal to 10.0 μm and 20.0 μm, the strain energy is small and the energy of the vibration leakage is suppressed.

Additionally, in the disk resonator according to the reference example, various values were set to a length of the supporting joist, and strain energy was obtained for each value. FIG. 14C shows the result. In the reference example, even if the value of 10 μm, which leads to the minimum strain energy, was set, the strain energy was not equal to or less than the reference value 1. Compared with the reference example that includes the structure corresponding to FIG. 5A, the disk resonators according to the embodiments of this disclosure allow suppressing the strain energy, which leaks out, to be equal to or less than 1/100, thus having an extremely significant effect.

The disk resonator according to this disclosure may be configured as follows. The contour mode disk resonator includes a disk-shaped vibration plate, a pair of input electrodes, a pair of output electrodes, a supporting joist with one end and another end, and an absorbing portion. The disk-shaped vibration plate is supported above a substrate so as to face the substrate via a clearance. A bias voltage is to be applied to the vibration plate. The pair of input electrodes is disposed to face one another via the vibration plate in a planar view, so as to vibrate the vibration plate in a wine glass mode. The pair of output electrodes is disposed to face one another via the vibration plate in a direction intersecting with a direction where the pair of input electrodes faces one another in the planar view, so as to obtain an output signal based on a vibration of the vibration plate. The one end is integrally secured to a portion corresponding to a vibration node that occurs by a contour vibration in an outer periphery of the vibration plate. The supporting joist extends outward in a radial direction of the vibration plate. The other end is supported by the substrate. The absorbing portion is disposed between a supporting portion of the substrate at the supporting joist and the one end, so as to absorb strain energy generated by the contour vibration in the supporting joist.

The disk resonator according to this disclosure may be configured as follows. The absorbing portion has an expanded portion where the supporting joist is expanded right and left with respect to a direction where the supporting joist extends. The expanded portion has a slit-shaped through hole that is longer than a width of a portion adjacent to the expanded portion of the supporting joist. The slit-shaped through hole extends right and left.

Alternatively, a disk resonator according to this disclosure may be configured as follows. The contour mode disk resonator includes a disk-shaped vibration plate, a pair of input electrodes, a pair of output electrodes, and a supporting joist with one end. The disk-shaped vibration plate is supported above a substrate so as to face the substrate via a clearance. A bias voltage is to be applied to the vibration plate. The pair of input electrodes is disposed to face one another via the vibration plate in a planar view, so as to vibrate the vibration plate in a wine glass mode. The pair of output electrodes is disposed to face one another via the vibration plate in a direction intersecting with a direction where the pair of input electrodes faces one another in the planar view, so as to obtain an output signal based on a vibration of the vibration plate. The one end is integrally secured to a portion corresponding to a vibration node that occurs by a contour vibration in an outer periphery of the vibration plate. The supporting joist includes a main joist, a pair of subsidiary joists, and a weight portion. The main joist extends outward from the vibration plate in a radial direction of the vibration plate. The pair of subsidiary joists extends from a middle portion of the main joist right and left with respect to a direction where the main joist extends. A distal end side of each of the subsidiary joists is supported by the substrate. The weight portion is disposed on another end side with respect to the middle portion of the main joist.

An electronic component according to this disclosure includes the aforementioned disk resonator.

In a contour mode disk resonator according to the present invention where the vibration plate is vibrated in the wine glass mode, a supporting joist, which extends outward from a vibration node occurring in the outer peripheral portion of a vibration plate and is integrally with the vibration plate, has an absorbing portion that absorbs strain energy. Thus, when a contour vibration in the wine glass mode occurs in the vibration plate, the strain energy generated in the supporting joist is absorbed in the absorbing portion. Since the strain energy generated in the supporting joist is reduced, vibration leakage is suppressed, thus suppressing deterioration of the Q-value.

In another disclosure, the supporting joist includes the main joist, which extends outward from the vibration plate, the pair of subsidiary joists, which symmetrically extend from the right and left sides of the middle portion of the main joist, and the weight portion, which is disposed at the distal end of the main joist, such that each of the subsidiary joists is a support point. Thus, when the contour vibration occurs in the vibration plate, the weight portion vibrates, thus forming a vibration node at the middle portion.

Accordingly, a moment generated at the middle portion is reduced, and strain energy, which is generated in a portion for securing the supporting joist and the vibration plate, is reduced. This suppresses leakage of vibration energy from the vibration plate to the supporting joist, thus suppressing the deterioration of the Q-value.

The principles, preferred embodiment and mode of operation of the present invention have been described in the foregoing specification. However the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A contour mode disk resonator, comprising:
a substrate;
a disk-shaped vibration plate, being supported above the substrate so as to face the substrate via a clearance, a bias voltage being to be applied to the vibration plate;
a pair of input electrodes, disposed to face one another via the vibration plate in a planar view, so as to vibrate the vibration plate in a wine glass mode;
a pair of output electrodes, disposed to face one another via the vibration plate in a direction intersecting with a direction where the pair of input electrodes face one another in the planar view, so as to obtain an output signal based on a vibration of the vibration plate; and
a supporting joist with one end, the one end being integrally secured to a portion corresponding to a vibration node, the vibration node occurring by a contour vibration in an outer periphery of the vibration plate, wherein,
the supporting joist includes an absorbing portion configured to absorb strain energy generated by the contour vibration in the supporting joist.

2. The disk resonator according to claim 1, wherein
the supporting joist extends outward in a radial direction of the vibration plate,
the supporting joist includes another end that is supported by the substrate, and
the absorbing portion is disposed between the other end and the one end.

3. The disk resonator according to claim 2, wherein
the absorbing portion has an expanded portion where the supporting joist is expanded right and left with respect to a direction where the supporting joist extends, and
the expanded portion has a slit-shaped through hole that is longer than a width of a portion adjacent to the expanded portion of the supporting joist, the slit-shaped through hole extending right and left.

4. The disk resonator according to claim 1, wherein
the absorbing portion includes:
a main joist that extends outward from the vibration plate in a radial direction of the vibration plate;
a pair of subsidiary joists that extends from a middle portion of the main joist right and left with respect to a direction where the main joist extends, each of the subsidiary joists being supported by the substrate; and
a weight portion disposed on another end side with respect to the middle portion of the main joist.

5. An electronic component, comprising:
the disk resonator according to claim 1.

6. An electronic component, comprising:
the disk resonator according to claim 2.

7. An electronic component, comprising:
the disk resonator according to claim 3.

8. An electronic component, comprising:
the disk resonator according to claim 4.
